(19) United States
(12) Patent Application Publication
(10) Pub. No.: US 2017/0139244 A1
(43) Pub. Date: May 18, 2017

(54) DISPLAY PANEL, AND METHOD FOR CURING SEALANT THEREOF AND DISPLAY APPARATUS

(71) Applicants: BOE Technology Group Co., Ltd., Beijing (CN); Hefei Xinsheng Optoelectronics Technology Co., Ltd., Anhui (CN)

(72) Inventors: Bo Zhang, Beijing (CN); Cong Tan, Beijing (CN); Chengyong Zhan, Beijing (CN); Fangfang Li, Beijing (CN); Kai Wang, Beijing (CN)

(21) Appl. No.: 15/105,288

(22) PCT Filed: Oct. 15, 2015
(86) PCT No.: PCT/CN2015/092010

§ 371 Date: Jun. 16, 2016

(30) Foreign Application Priority Data
May 7, 2015 (CN) 201510230319.8

(51) Int. Cl. G02F 1/1339; G02F 1/1335

(52) U.S. Cl. CPC G02F 1/1339; G02F 1/133514; G02F 1/133504; G02F 1/133512

(57) ABSTRACT

This present invention provides a display panel, a method for curing a sealant thereof, and a display apparatus. This display panel comprises a first substrate and a second substrate, which are oppositely provided, and a sealant structure for binding the first substrate and the second substrate, wherein the sealant structure comprises a sealant and a conversion unit, and the conversion unit is used for converting infrared light, which irradiates it when the sealant is being cured, to ultraviolet light. With respect to the display panel provided by the invention, photocuring and thermocuring are achieved with a one-step process by providing a conversion unit in the sealant structure so as to prevent the problems in liquid crystal contamination, puncture, and the like, for the reason that the incompletely pre-cured sealant is prone to become in contact with liquid crystal, when ultraviolet photocuring and thermocuring are performed on a sealant separately.

### TECHNICAL FIELD

The invention relates to the field of display, and particularly to a display panel, a method for curing a sealant thereof, and a display apparatus.

### BACKGROUND ART

A liquid crystal display panel is cell-assembled with an array substrate 1 and a color filter substrate 2. As shown in FIG. 1, the array substrate 1 and the color filter substrate 2 are bonded with a sealant 5 to form an enclosed space, in which liquid crystal is filled, and display is achieved by controlling liquid crystal molecules in a display area 3. Here, the curing of the sealant 5 is a very important process step in a cell-assembling process of a liquid crystal display panel.

At present, the curing process for a sealant is mainly divided into two steps: first irradiating a liquid crystal display panel with ultraviolet light (UV) for pre-curing, and transferring the liquid crystal display panel to a heating furnace for high-temperature thermocuring. In this way, complete curing of the sealant is achieved.

As the requirements for plate displays are higher, the narrow-border technique has become the mainstream of display. In the narrow-border technique, in order to prevent the generation of light leak, a black matrix (BM) 4 is required to be provided between the sealant 5 and the color filter substrate 2. Thus, since ultraviolet light cannot penetrate the black matrix 4 upon ultraviolet photocuring, ultraviolet photocuring has to be performed by irradiating from gaps of metal wires 6 at the side of the array substrate 1. This causes the problems of uneven curing and incomplete curing of the sealant for the reason that ultraviolet light is shaded by metal wires 6 when the sealant is pre-cured with ultraviolet light. Thereafter, when the display panel is moved for thermocuring, the sealant 5 is prone to become in contact with liquid crystal in the cell, resulting in the problems inliquid crystal, such as contamination, puncture, and the like.

### SUMMARY OF THE INVENTION

(I) Technical Problem to be Solved

The technical problem to be solved by the inventionmay be how to prevent the problems in liquid crystal, such as contamination, puncture, and the like,for the reason that the sealant is prone to become in contact with liquid crystal,when ultraviolet photocuring and thermocuring are performed on a sealant separately.

(II) Technical Solutions

At least in order to solve the technical problem described above, a technical solution of the invention provides a display panel, comprising a first substrate and a second substrate, which are oppositely provided, characterized by further comprising a sealant structure for binding the first substrate and the second substrate, wherein the sealant structure comprises a sealant and a conversion unit, and the conversion unit is used for converting infrared light,which irradiates the conversion unit when the sealant is being cured, to ultraviolet light.

Preferably, the conversion unit comprises an upconversion material provided in the sealant.

More preferably, the upconversion material is uniformly doped in the sealant.

Preferably, the conversion unit comprises a thin film produced from an upconversion material, and the thin film is provided between the second substrate and the sealant, and theprojection of the thin film on the second substrate andthe projection of the sealant on the second substrateat least partly overlap.

More preferably, a black matrix is further provided between the second substrate and the thin film, and the projection of the black matrix on the second substrate and the projection of the sealant on the second substrate at least partly overlap.

Preferably, the conversion unit comprises a variety of upconversion materials, and the variety of upconversion materials stepwise upconvert the infrared light to the ultraviolet light.

Preferably, the upconversion material comprises a base material and rare earth ions doped in the base material.

More preferably, the base material comprises one or more of a fluoride, an oxide, a sulfur-containing compound, an oxyfluoride, and a halide.

More preferably, the rare earth ion comprises one or more of ions of lanthanide (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y).

Preferably, the display panel further comprises an energy diffusion layer provided between the first substrate and the sealant, and the projection of the energy diffusion layer on the first substrate and the projection of the sealant on the first substrate at least partly overlap.

More preferably, the energy diffusion layer comprises a light scattering material.

Preferably, the display panel is a liquid crystal display panel, the first substrate is an array substrate, and the second substrate is a color filter substrate.

In order to solve the technical problem described above, the invention further provides a display apparatus, comprising any one of the display panels described above.

The invention also provides a method for curing the sealant structure in the display panel of the invention, characterized by irradiating the conversion unit and the sealant with infrared light, and curing the sealant structure by curing with ultraviolet light generated by upconversion, and thermocuring with infrared light.

More preferably, the conversion unit is irradiated with infrared light from the side of the first substrate.

(III) Advantageous Effects

With respect to the display panel provided by the invention, by providing a conversion unit in the sealant structure, it is possible to both achieve thermocuring with infrared light and achieve ultraviolet photocuring with a conversion unit for converting infrared light, which irradiates a conversion unit when the sealant is being cured, to ultraviolet light in one process step. This prevents the problemsdue to incomplete pre-curing when ultraviolet photocuring and thermocuring are performed on a sealant separately, for example the problems in liquid crystal, such as contamination, puncture, and the like, for the reason that the incompletely pre-cured sealant is prone to become in contact with liquid crystal in the liquid crystal display panel.

### DESCRIPTION OF DRAWINGS

FIG. 1 is a schematic diagram of a partial structure of a display panel in the prior art being subjected to ultraviolet photocuring;

FIG. 2 is a sectional view of a partial structure of a display panel provided in a first Example of the invention; and

FIG. 3 is a sectional view of a partial structure of a display panel provided in a second Example of the invention.

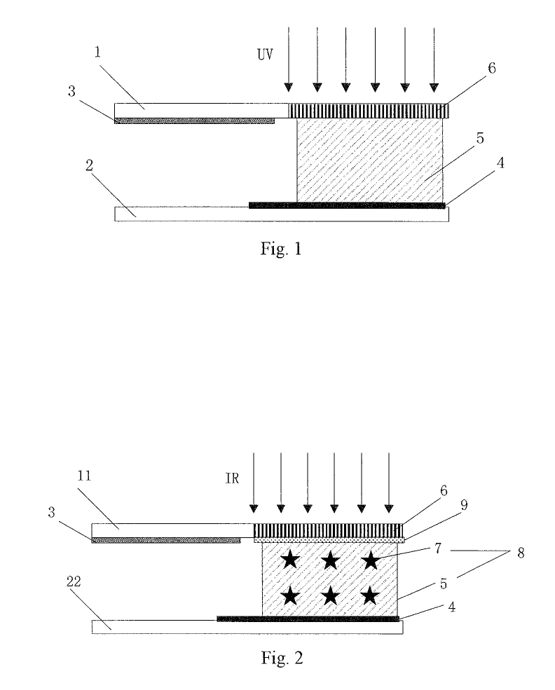

### REFERENCE NUMERALS

1—array substrate

11—first substrate

2—color filter substrate

22—second substrate

3—display area

4—black matrix

5—sealant

6—metal wire

7—conversion unit

8—sealant structure

9—energy diffusion layer

### DESCRIPTION OF EMBODIMENTS

When a sealant is cured, the sealant is first subjected to ultraviolet photocuring, and then subjected to thermocuring. Due to shading by metal wires, uneven curing and incomplete curing are prone to occur in the sealant subjected to pre-curing with ultraviolet light. Thus, when the display panel is moved for thermocuring, the sealant is prone to become in contact with liquid crystal due to incomplete pre-curing, resulting in the problems in liquid crystal, such as contamination, puncture, and the like.

An Example of the invention provides a display panel and a display apparatus. This display panel comprises a first substrate and a second substrate, which are oppositely provided, and a sealant structure for binding the first substrate and the second substrate. In a technical solution of the invention, by providing a conversion unit in the sealant structure, infrared light (IR), which irradiates the conversion unit when the sealant is being cured, is converted to ultraviolet light (UV). Thus, it is possiblein one process step to both achieve thermocuring with infrared light and achieve ultraviolet photocuringbyconverting infrared light, which irradiates a conversion unit when the sealant is being cured, to ultraviolet lightwith the conversion unit. The complete curing of the sealant can be achieved with a one-step process so as to prevent the problems in liquid crystal in the prior art, where sealant curing is achieved with a two-step process, such as contamination, puncture, and the like,caused by that the display panel is moved with incomplete pre-curing.

Specific embodiments of the invention will be further described in detail in conjunction with accompanying drawings and examples. The examples below are provided to illustrate the invention but are not intended to limit the scope of the invention.

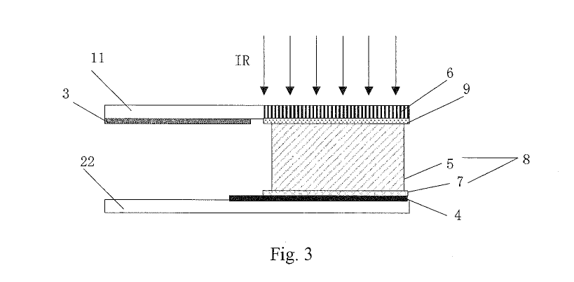

As shown in FIGS. 2 and 3, this display panel comprises a first substrate 11 and a second substrate 22, which are oppositely provided, and a sealant structure 8 for binding the first substrate 11 and the second substrate 22, wherein the sealant structure 8 comprises a sealant 5 and a conversion unit 7, and the conversion unit 7 is used for converting infrared light (IR), which irradiates the conversion unit 7 when the sealant 5 is being cured, to ultraviolet light (UV). The ultraviolet light may promote decomposition of the photosensitizer in the sealant 5 to release catalyst free radicals and accelerate photocuring of the sealant. Thermocuring and photocuring are achieved in a one-step process, and complete curing of the sealant 5 is finally achieved.

It is to be indicated that infrared light has a wavelength in a range of 0.75 μm-1000 μm, and ultraviolet light has a wavelength in a range of 0.01 μm-0.4 μm. As can be seen, the wavelength of infrared light is greater than that of ultraviolet light. Thus, infrared light exhibits stronger transmittance to allow that infrared light passes through themetal wires 6 more easily to arrive at the sealant 5, and infrared light has a certain thermal effect, which allows for the achievement of thermocuring.

With respect to the display panel provided by an Example of the invention, by providing a conversion unit 7 in the sealant structure 8 of the display panel, infrared light (IR), which irradiates the conversion unit 7 when the sealant 5 is being cured, is converted to ultraviolet light (UV). In a one-step process, it is possible to achieve both thermocuring and ultraviolet photocuring with infrared light, so as to prevent problems in liquid crystal, such as contamination, puncture, and the like, when ultraviolet photocuring and thermocuring are performed on a sealant 5 separately.

With respect to the display panel provided by an Example of the invention, thermocuring and ultraviolet photocuring may be achieved only with a one-step process when the sealant is being cured. Therefore, it is possible to reduce production time of products and improve production capacity, and meanwhile, defects, such as Mura, etc., generated for the reason that relative displacement is prone to occur between the first substrate 11 and the second substrate 22 due to incomplete pre-curing of the sealant 5, if the display panel is moved before thermocuring.

Specifically, in a first Example of the invention, as shown in FIG. 2, the conversion unit 7 comprises an upconversion material provided in the sealant 5. When the infrared light passes throughthe metal wires 6 and the sealant 5 and irradiates the upconversion material provided in the sealant 5, the upconversion material may convert the infrared light irradiating it to ultraviolet light. The ultraviolet light generated by theconversion performs ultraviolet photocuring on the sealant 5, and the unconverted infrared light performs thermocuring on the sealant 5 with its thermal effect.

Optionally, the upconversion material may include more than one type. For example, when the upconversion material includes one type, this upconversion material directly converts the infrared light irradiating it to ultraviolet light; when the upconversion material includes two types, one type of the upconversion material converts the infrared light irradiating it to visible light, and the other type converts the visible light to ultraviolet light.

Preferably, the upconversion material is uniformly doped in the sealant 5, which may generate uniform ultraviolet light to allow for uniform curing of the sealant.

The invention also provides a second Example. As shown in FIG. 3, the infrared light comes from the side of the first substrate 11 to cure the sealant. The upconversion unit 7 comprises a thin film produced from an upconversion material, and the thin film is provided on the second substrate 22, and the projection of the thin film on the second substrate 22 and the projection of the sealant 5 on the second substrate 22at least partly overlap.

The thin film can convert the infrared light irradiating it to ultraviolet light. The ultraviolet light may promote decomposition of the photosensitizer in the sealant 5 to release catalyst free radicals and accelerate photocuring of the sealant. Thermocuring and photocuring are achieved in a one-step process, and complete curing of the sealant 5 is finally achieved.

As shown in FIG. 3, a black matrix 4 is further provided on the second substrate 22, and the projection of the black matrix 4 on the second substrate 22 and the projection of the sealant on the second substrate at least partly overlap. Preferably, the thin film is provided above the black matrix 4 in order to prevent the effect of the black matrix 4 on light. Of course, if the black matrix 4 has a block-like or a slit-like structure, the thin film may also be provided below the black matrix 4, and it is not defined herein.

It is to be indicated that the upconversion materials in the two Examples described above can achieve upconversion light emission, i.e., Anti-Stokes light emission, which comes from Stokes law. It is considered according tothe so-called Stokes law that a material can be only excited by a light with a high energy to emit a light with a low energy. In other words, a light with a short wavelength and a high frequency excites the emission of a light with a long wavelength and a low frequency. For example, ultraviolet excites the emission of visible light, blue light excites the emission of yellow light, or visible light excites the emission of infrared. However, it has been later found that some materials may actually achieve a light emission effect which is exactly opposite to the above law.Excited light emission of these materials are known as Anti-Stokes light emission, i.e., upconversion light emission.

Specifically, the upconversion material comprises a base material and rare earth ions doped in the base material; the base material comprises one or more of a fluoride, an oxide, a sulfur-containing compound, an oxyfluoride, and a halide; the rare earth ion comprises one or more of ions of lanthanide (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y).

Preferably, NaYF₄ is used as a base material. As the base material having the highest efficiency of upconversion light emission, NaYF₄ can improve the efficiency of light emission. Meanwhile, Yb³⁺ ions are doped and used as a sensitizer to enhance the absorption capacity for theexcitinglight.

In the first Example provided by the invention, when the upconversion material includes one type, specifically, the upconversion material is Y_{1.838-X}GdₓYb_{0.16}Ho_{0.002}O₃ enhanced by doping Gd³⁺ ions (wherein X=0.16, 0.4, 1.0, 1.4, and preferably X is 1.0), which emits ultraviolet lights having wavelengths of 309 nm and 315 nm under the excitation of an infrared light of 976 nm. When it is doped in the sealant 5, under the irradiation of infrared light, the infrared light may bypass and penetrate metal wires 6 to a place below it to excite the upconversion material. The upconversion material is excited to emit ultraviolet light for performing photocuring on the sealant 5 nearby, and at the meanwhile infrared light has a stronger thermal effect for simultaneously performing preliminary thermocuring on the sealant.

Otherwise, when the upconversion material includes two types, specifically, the upconversion material is YF₃:Yb³⁺ doped with Er³⁺ and NaYF₄ doped with Er³⁺, wherein the former may be excited by infrared light to emit a green light of about 500 nm and the latter may be excited by the green light to emit ultraviolet lights of 310 nm and 340 nm, such that the sealant 5 is subjected to photocuring.

Furthermore, as shown in FIGS. 2 and 3, the infrared light comes from the side of the first substrate 11 to cure the sealant 5. The display panel further comprises an energy diffusion layer 9 provided between the first substrate 11 and the sealant 5, and the projection of the energy diffusion layer 9 on the first substrate 11 and the projection of the sealant on the first substrate 11 at least partly overlap.

When the energy diffusion layer 9 is irradiated by the infrared light, the energy diffusion layer 9 can uniformly disperse and radiate the infrared light onto the sealant 5 to allow for uniform curing of the sealant.

Specifically, the energy diffusion layer 9 comprises a light scattering material. The infrared light absorbed by the light scattering material is scattered and then uniformly irradiates the sealant 5.

Here, the light scattering material includes an area scattering material and a volume scattering material, and may be a light scattering material prepared by in situ polymerization with polystyrene as a scattering material, or, may be a composite light scattering material prepared from metal oxides such as nanoscale Al2O3, SiO2, CaO, etc. by using polymethyl acrylate-based organics as a matrix. It can be understood that light scattering materials prepared by other methods may also be comprised in the energy diffusion layer 9, and verbose words are omitted herein.

The invention is particularly suitable for liquid crystal display panels. The reason is as follows.The liquid crystal display panel particularly requires good sealing of the sealant and a black matrix is typically provided on the side of thecolor filter substrate to prevent light leak.Ultraviolet light is shaded by metal wires on the side of thearray substrate to prevent pre-curing by direct irradiation of ultraviolet light.The sealant and liquid crystal are brought into contact upon movement between steps of a two-step method, resulting in the problems in liquid crystal, such as contamination, puncture, and the like.

An Example of the invention also provides a display apparatus, and this display apparatus comprises any one of the display panels described above.

A conversion unit is provided in the sealant structure of the display panel, and is used for converting infrared light, which irradiates the conversion unit when the sealant is being cured, to ultraviolet light. Thus, it is possible to both achieve thermocuring with infrared light and achieve ultraviolet photocuringby converting infrared light, which irradiates a conversion unit when the sealant is being cured, to ultraviolet light in one process stepwith a conversion unit, so as to prevent problems related to incomplete curing of the sealant between steps of a two-step method, such as the problems in liquid crystal in the liquid crystal display panel, such as contamination, puncture, and the like.

An Example of the invention also provides a method for curing the sealant structure in the display panel of the invention, characterized in that the conversion unit and the sealant are irradiated with infrared light, and the sealant structure is cured by photocuringwith ultraviolet light generated by upconversion, and thermocuring with infrared light. By means of irradiation of infrared light, it is possible to both achieve thermocuring with infrared light and achieve ultraviolet photocuring unit byconverting infrared light, which irradiates a conversion unit when the sealant is cured, to ultraviolet light in one process stepwith a conversion, so as to prevent problems related to incomplete curing of the sealant between steps of a two-step method, such as the problems in liquid crystal in the liquid crystal display panel, such as contamination, puncture, and the like.

The infrared light comespreferably from the side of the first substrate. That is, when display panel has optionally an energy diffusion layer, an upconversion material thin film, and/or a black matrix, irradiation is performed from the side of the energy diffusion layer, which is opposite to the side of the upconversion material thin film and the black matrix.

The above embodiments are merely provided to illustrate the invention but are not intended to limit the invention. With respect to those of ordinary skill in the related art, various changes and variations can also be made without departing from the spirit and the scope of the invention. Therefore, all equivalent technical solutions are also within the scope of the invention, and the patent scope protected by the invention should be defined by the claims.

1. A display panel, comprising a first substrate and a second substrate, which are oppositely provided, wherein the display panel further comprisesa sealant structure for binding the first substrate and the second substrate, the sealant structure comprises a sealant and a conversion unit, and the conversion unit is used for converting infrared light, which irradiates the conversion unit when the sealant is being cured, to ultraviolet light.

2. The display panel according to claim 1, wherein the conversion unit comprises an upconversion material provided in the sealant.

3. The display panel according to claim 2, wherein the upconversion material is uniformly doped in the sealant.

4. The display panel according to claim 1, wherein the conversion unit comprises a thin film produced from an upconversion material, and the thin film is provided between the second substrate and the sealant, and the projection of the thin film on the second substrate and the projection of the sealant on the second substrateat least partly overlap.

5. The display panel according to claim 4, wherein a black matrix is further provided between the second substrate and the thin film, and the projection of the black matrix on the second substrate and the projection of the sealant on the second substrate at least partly overlap.

6. The display panel according to claim 1, wherein the conversion unit comprises a pluralityof upconversion materials, and the plurality of upconversion materials stepwise upconvert the infrared light to the ultraviolet light.

7. The display panel according to claim 2, wherein the upconversion material comprises a base material and rare earth ions doped in the base material.

8. The display panel according to claim 7, wherein the base material comprises one or more of a fluoride, an oxide, a sulfur-containing compound, an oxyfluoride, and a halide.

9. The display panel according to claim 7, wherein the rare earth ion comprises one or more of ions of lanthanide (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y).

10. The display panel according to claim 1, wherein the display panel further comprises an energy diffusion layer provided between the first substrate and the sealant, and the projection of the energy diffusion layer on the first substrate and the projection of the sealant on the first substrate at least partly overlap.

11. The display panel according to claim 10, wherein the energy diffusion layer comprises a light scattering material.

12. The display panel according to claim 1, wherein the display panel is a liquid crystal display panel, the first substrate is an array substrate, and the second substrate is a color filter substrate.

13. A display apparatus, characterized by comprising the display panel of claim 1.

14. A method for curing the sealant structure in the display panel of claim 1, wherein the conversion unit and the sealant are irradiated with infrared light, and the sealant structure is cured by photocuringwith ultraviolet lightobtained from upconversion, and thermocuring with infrared light.

15. The method according to claim 14, wherein the conversion unit is irradiated with infrared light from the side of the first substrate.

16. The display panel according to claim 4, wherein the upconversion material comprises a base material and rare earth ions doped in the base material.

17. The display panel according to claim 16, wherein the base material comprises one or more of a fluoride, an oxide, a sulfur-containing compound, an oxyfluoride, and a halide.

18. The display panel according to claim 16, wherein the rare earth ion comprises one or more of ions of lanthanide (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y).

19. The display panel according to claim 6, wherein the upconversion material comprises a base material and rare earth ions doped in the base material.

20. The display panel according to claim 19, wherein the base material comprises one or more of a fluoride, an oxide, a sulfur-containing compound, an oxyfluoride, and a halide.

21. The display panel according to claim 19, wherein the rare earth ion comprises one or more of ions of lanthanide (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y).
